(19) United States
(12) Patent Application Publication
(10) Pub. No.: US 2024/0385762 A1
(43) Pub. Date: Nov. 21, 2024

(54) STORAGE SYSTEM

(71) Applicant: Hitachi, Ltd., Tokyo (JP)

(72) Inventor: Nagamasa MIZUSHIMA, Tokyo (JP)

(21) Appl. No.: 18/367,352

(22) Filed: Sep. 12, 2023

(30) Foreign Application Priority Data
May 17, 2023 (JP) 2023-081593

(51) Int. Cl. G06F 3/06

(52) U.S. Cl. CPC G06F 3/0647; G06F 3/0608; G06F 3/067

(57) ABSTRACT

Each storage node includes a processor, a drive that stores data, and a communication unit that transmits data to another storage node or receives data from the another storage node. The communication unit includes a compression circuit that performs reversible compression before data is transmitted and a decompression circuit that decompresses compressed data after the compressed data is received. In response to a reading command for reading data of a designated size to the outside, when a predetermined condition is satisfied, the communication unit of a first storage node compresses the data stored in the drive of the first storage node by the compression circuit and transmits the compressed data to the communication unit of a second storage node. The communication unit of the second storage node decompresses the received data with a decompression circuit. The second storage node outputs decompressed data to an outside.

### CLAIM OF PRIORITY

The present application claims priority from Japanese patent application JP 2023-081593 filed on May 17, 2023, the content of which is hereby incorporated by reference into this application.

### BACKGROUND OF THE INVENTION

### 1. Field of the Invention

The present invention relates to a storage system.

### 2. Description of the Related Art

In the storage system that is an information device accumulating and managing a large amount of data, preferably a data capacity can be easily expanded when more data is required to be stored. Accordingly, there is the storage system that is configured such that a plurality of storage nodes can be interconnected and such that the number of storage nodes to be connected can be increased by a required number later. This is referred to as a multi-node connection configuration storage system.

In such the storage system, a host that gives an instruction to read/write data is connected to each storage node. At this point, in a case where the data is stored in the storage node to which the host is not connected when the data is read by a read command from the host, data transfer between the storage nodes is required to be performed. In addition, when the data is written by a write command from the host, the data transfer for backup to another storage node is required to be performed in preparation for a failure of the storage node to which the host is connected.

In the multi-node connection configuration storage system, when a communication bandwidth between the storage nodes is not sufficiently large, the bandwidth becomes a bottleneck to performance of the host to read/write the data. For this reason, the communication bandwidth between the storage nodes is desirably expanded. There are two implementation means, one is to increase the number of mounted communication devices that perform communication between storage nodes, and the other is to reduce the amount by compressing communication data between the storage nodes.

A disadvantage of the former means is that the cost of the system increases due to the mounting of the communication device. A disadvantage of the latter means is that a time required for command processing increases by the amount of compression and expansion processing, and response performance is degraded. When the time required for the compression and expansion processing can be reduced, desirably the latter means is selected at low cost.

As an example of a connection system between the storage nodes, there is a connection system such as Ethernet or PCI express. As a communication means therein, there is a method for dividing data into a plurality of pieces of data, embedding the plurality of pieces of data in a payload of an IP packet or a transaction layer packet (TLP), and transmitting and receiving the plurality of pieces of data.

As a conventional technique, RFC-3173 (IP Payload Compression Protocol) defines a protocol for compressing payload data in order to reduce the amount of IP packets transmitted on the Ethernet. This technique has the following features: each payload is independently compressed by a dictionary compression algorithm. The condition for applying the compression defines only “a case where a payload size does not increase due to the compression”. How to determine the payload size is not specified.

### SUMMARY OF THE INVENTION

In the related art regarding communication data compression including RFC-3173 (IP Payload Compression Protocol), a method for preventing degradation of response performance of the storage system by reducing a time required for compression/decompression processing when communication data between storage nodes in the storage system is compressed to reduce an amount is not disclosed.

One aspect of the present invention is a storage system including a plurality of storage nodes, in which each storage node of the plurality of storage nodes includes: a processor that processes an instruction from an outside; a drive that stores data; and a communication unit that transmits data to another storage node or receives data from the another storage node, the communication unit includes a compression circuit that performs reversible compression before data is transmitted and a decompression circuit that decompresses compressed data after the compressed data is received, when a predetermined condition is satisfied, the communication unit of a first storage node compresses the data stored in the drive of the first storage node by the compression circuit and transmits the compressed data to the communication unit of a second storage node in response to a reading command for reading data of a designated size to the outside, the communication unit of the second storage node decompresses the received data using the decompression circuit, and the second storage node outputs the decompressed data to the outside.

One aspect of the present invention is a storage system including a plurality of storage nodes, in which each storage node of the plurality of storage nodes includes: a processor that processes an instruction from an outside; a drive that stores data; a cache memory; and a communication unit that transmits data to another storage node or receives data from the another storage node, the communication unit includes a compression circuit that performs reversible compression before data is transmitted and a decompression circuit that decompresses compressed data after the compressed data is received, when a predetermined condition is satisfied, the communication unit of the first storage node compresses the data of the cache memory of the first storage node by the compression circuit and transmits the compressed data to the communication unit of the second storage node in response to a writing command for writing received data of a designated size from the outside, the communication unit of the second storage node decompresses the received data using the decompression circuit, and the second storage node stores the decompressed data to the cache memory.

An aspect of the present invention is a storage system including a plurality of storage nodes, in which each storage node of the plurality of storage nodes includes: a cache memory; and a communication unit that transmits data to another storage node or receives data from the another storage node, the communication unit includes a compression circuit that performs reversible compression before data is transmitted and a decompression circuit that decompresses compressed data after the compressed data is received, the communication unit of a first storage node divides data into a plurality of pieces of partial data with a maximum payload size of write packet from the communication unit to the cache memory as a division unit, and transmits packet having a payload obtained by compressing the partial data using the compression circuit to the communication unit of the second storage node, and the communication unit of the second storage node that receives the packet decompresses the payload of the received packet by the decompression circuit, configures write packet including the decompressed payload, and transfers the write packet to the cache memory of the second storage node.

According to one aspect of the present invention, the degradation of the response performance can be prevented in the storage system having a function of compressing the communication data between the storage nodes.

### BRIEF DESCRIPTION OF THE DRAWINGS

FIG. 1 illustrates a configuration of a storage system to which the present invention is applied;

FIG. 2 illustrates a configuration of an internode communication unit;

FIG. 3 is a flowchart illustrating a read command of data stored in an uncompressed state;

FIG. 4 illustrates a first half of a flowchart of a write command of data stored in an uncompressed state;

FIG. 5 illustrates a second half of the flowchart of the write command of the data stored in the uncompressed state;

FIG. 6 is a flowchart illustrating a read command of data stored in a compressed state;

FIG. 7A illustrates a method for calculating maximum read performance;

FIG. 7B illustrates a change in read performance with respect to a CPU operation rate;

FIG. 8 is a flowchart determining a compression condition of internode transfer;

FIG. 9A illustrates a data flow of compression/decompression by the internode communication unit;

FIG. 9B illustrates an example of dictionary compression;

FIG. 10 illustrates division compression of internode transfer data;

FIG. 11 illustrates a configuration of a packet transmitted and received by the internode communication unit;

FIG. 12 is a flowchart processing performed by a compression circuit;

FIG. 13 is a flowchart processing performed on a received packet by the internode communication unit; and

FIG. 14 illustrates a change in a transmission output speed from the internode communication unit according to a second embodiment.

### DESCRIPTION OF THE PREFERRED EMBODIMENTS

Hereinafter, embodiments will be described with reference to the drawings. An example is merely an example implementing the present invention, does not limit the technical scope of the present invention, and all combinations of features described in the example is not necessarily essential to the solution of the invention.

In the following description, various types of information may be described with an expression of “xxx table”, but the various types of information may be expressed with a data structure other than the table. The “xxx table” can be referred to as “xxx information” to indicate that the “xxx table” does not depend on the data structure. In the following description, a number is used as identification information about an element, but another type of identification information (for example, a name or an identifier) may be used.

In the following description, a common sign (or a reference sign) may be used when the same type of elements are not distinguished from each other, and a reference sign (or an element ID) may be used when the same type of elements are distinguished from each other.

A program is executed by a processor (for example, a central processing unit (CPU)) included in a storage controller, so that predetermined processing is appropriately performed using a storage resource (for example, a main storage) and/or a communication interface device. Consequently, a subject of the processing may be the storage controller or the processor. In addition, the storage controller may include a hardware circuit that performs a part or all of the processing. The computer program may be installed from a program source. For example, the program source may be a program distribution server or a computer-readable storage medium.

### (1) System Configuration

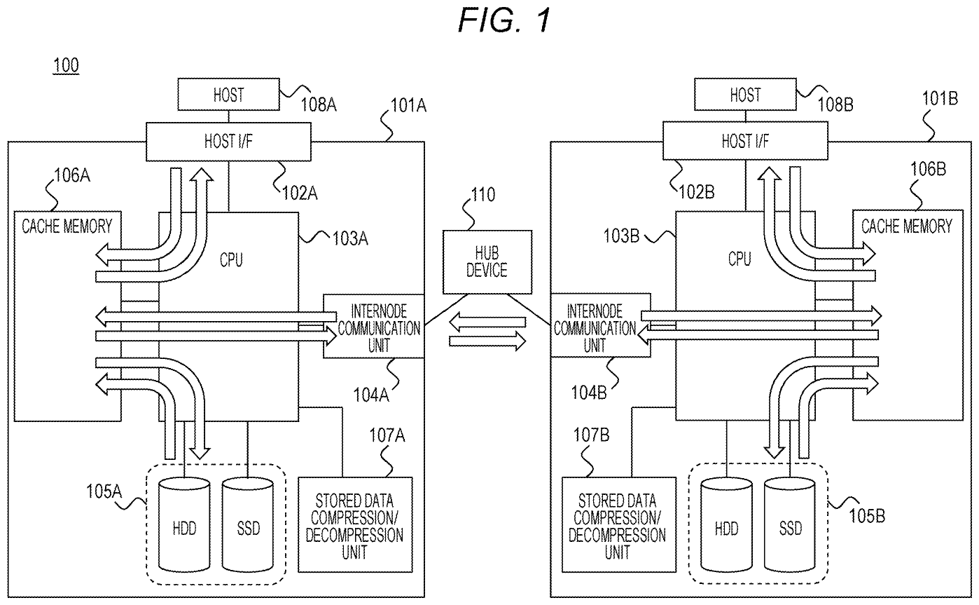

A storage system having a multi-node connection configuration will be described as an embodiment of the present description. FIG. 1 illustrates an internal configuration of a storage system 100 having the multi-node connection configuration. In this system, a plurality of storage nodes 101A, 101B is connected so as to be able to perform data communication with each other through a hub device 110, and the storage nodes 101A, 101B is connected to hosts 108A, 108B, respectively, that request reading/writing of data to be stored in the storage system 100 by a read/write command.

The number of storage nodes is not limited to two in FIG. 1, but may be greater than or equal to two. For example, when the number of storage nodes is four, four storage nodes are connected to the hub device 110, and data communication can be performed between any two of the four storage nodes. The communication device between the storage nodes is not limited to the hub device 110, but another communication device may be used in addition to or instead of the hub device 110.

In the embodiment described below, an internal configuration of each storage node is the same, and details of the component will be described below with A and B at an end of the number omitted.

The storage node 101 includes a host interface (I/F) 102, a CPU 103 that is a processor, an internode communication unit 104, a data storage medium 105, a cache memory 106, and a stored data compression/decompression unit 107.

The host I/F 102 is an interface mechanism connecting to the host 108, and responds to a read/write command from the host in order to transmit data to the host and receive data from the host. A mechanism of the host I/F 102 and a protocol transmitting and receiving the command and data conform to a standard interface standard, for example, a FibreChannel standard.

For example, the data storage medium 105 is a hard disk drive (HDD) or a solid state drive (SSD) on which a NAND flash memory that is a nonvolatile semiconductor memory is mounted, has a large capacity, and permanently stores the data received from the host. The data storage medium 105 is also referred to as a storage drive or simply a drive.

The cache memory 106 uses a volatile memory such as a dynamic random access memory (DRAM) as a medium, and temporarily holds the data received from the host 108 or the data read from the data storage medium 105.

In order to reduce the amount of data stored in the data storage medium 105, the stored data compression/decompression unit 107 reversibly compresses the write data received in response to the write command and generates compressed data. Furthermore, in order to transmit original plaintext data to the host 108 in response to the read command, the compressed data read from the data storage medium 105 is decompressed to generate the plaintext data. Whether to apply the compression by the stored data compression/decompression unit 107 to the data stored in the data storage medium 105 can be changed by an initial setting of the storage node 101.

The CPU 103 is connected to the host I/F 102, the internode communication unit 104, the data storage medium 105, the cache memory 106, and the stored data compression/decompression unit 107, and includes a plurality of microprocessors that control them. The CPU 103 executes data transfer between the internode communication unit 104 or the data storage medium 105 and the cache memory 106.

A data transfer protocol conforms to a standard interface standard, for example, a PCIexpress standard. In this case, the CPU 103 functions as RootComplex (parent), and the internode communication unit 104 or the data storage medium 105 function as EndPoint (child). In the PCIexpress standard, the data to be transferred is divided into a predetermined size, and transferred by being embedded in a payload portion of a transfer form called a packet. For example, a maximum payload size supported by the CPU 103 is 512 bytes.

The CPU 103 interprets a content of the read/write command from the host 108. In addition, the CPU 103 gives an instruction to perform data compression/decompression by the stored data compression/decompression device 107. Furthermore, the CPU 103 gives an instruction to perform the data transfer between the internode communication unit 104 or the data storage medium 105 and the cache memory 106.

In each storage node 101, first the write data from the host 108 is temporarily stored in the cache memory 106. When the data is initially set to be stored in the data storage medium 105 in an uncompressed state, the data is written as it is in the data storage medium 105. On the other hand, when the data is initially set to be stored in the data storage medium 105 in a compressed state, the data is converted into the compressed data through the stored data compression/decompression device 107, and the compressed data is temporarily stored in the cache memory 106. Then, the compressed data is written in the data storage medium 105.

In each storage node, the read data to the host 108 is read from the data storage medium 105 in the uncompressed state or the compressed state, and is temporarily stored in the cache memory 106. In the uncompressed state, the data is transmitted as it is to the host 108. On the other hand, in the compressed state, the data is converted into plaintext data through the stored data compression/decompression unit 107, and the plaintext data is temporarily stored in the cache memory 106. Then, the plaintext data is transmitted to the host 108.

The internode communication unit 104 is used when the data transfer between storage nodes is required during the processing according to the read/write command from the host 108. For example, the host 108A requests the storage node 101A to read the data stored in the data storage medium 105B in the storage node 101B other than the storage node 101A to which the host is connected. The data is transferred from the storage node 101B to the storage node 101A connected to the host 108A. Details including other cases will be described later.

The data transfer protocol between the storage nodes by the internode communication unit 104 conforms to a standard interface standard, for example, the PCI express standard. In this case, the hub device 110 functions as RootComplex (parent), and the internode communication unit 104 functions as EndPoint (child).

### (2) Internode Communication Unit

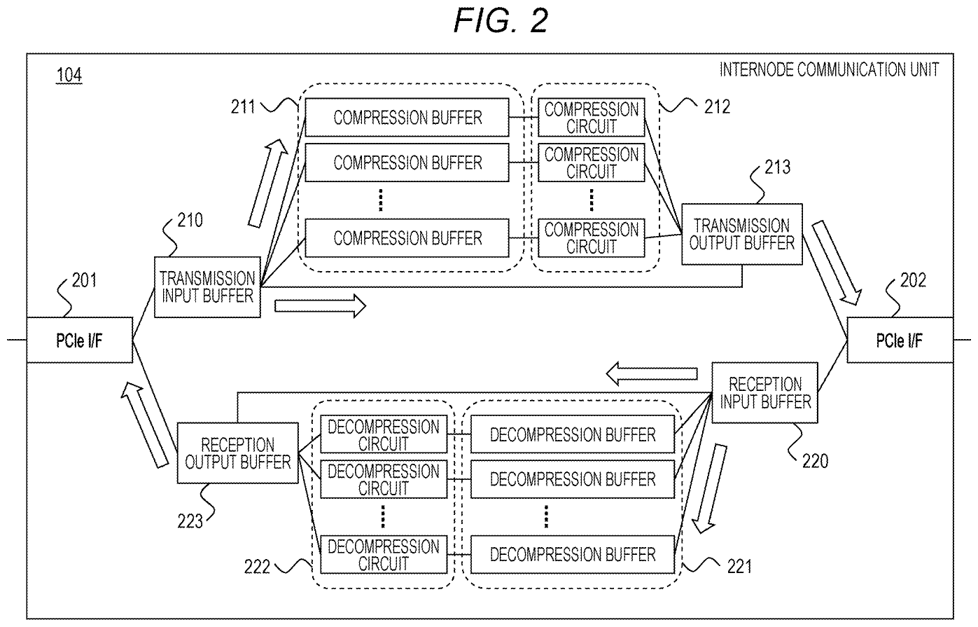

An internal configuration of the internode communication unit 104 will be described. FIG. 2 illustrates the internal configuration of the internode communication unit 104. The internode communication unit 104 includes a PCI express compliant interface (hereinafter referred to as PCIe I/F) 201 connected to the CPU 103 and a PCIe I/F 202 connected to the hub device 110. For example, when the data transfer is performed from the storage node 101A to the 101B, an internode communication unit 104A inputs the data from a CPU 103A through the PCIe I/F 201, and sends out the data from the PCIe I/F 202 to an internode communication unit 104B through the hub device 110. Then, the internode communication unit 104B receives the data through the PCIe I/F 202, and outputs the data from the PCIe I/F 201 to a CPU 103B.

The internode communication unit 104 includes four types of buffers 210, 213, 220, 223 that relay the transfer data between the PCIe I/F 201 and the PCIe I/F 202. The transmission input buffer 210 is a buffer memory receiving the data from the CPU 103. The transmission output buffer 213 is a buffer memory waiting for the data transmitted to another storage node. The reception input buffer 220 is a buffer memory holding the data received from another storage node. The reception output buffer 223 is a buffer memory causing the data transmitted to the CPU 103 to stand by.

When transferring the data from the transmission input buffer 210 to the transmission output buffer 213, the internode communication unit 104 can transfer the data without processing according to the instruction from the CPU 103, or can transfer the data after reversible compression. A plurality of compression circuits 212 is provided for the latter reversible compression. In the case of performing the reversible compression and transfer, the plurality of compression circuits 212 executes compression processing in parallel. The compression buffer 211 is a buffer memory provided for each compression circuit 212.

The transfer data is divided into a predetermined size and distributed to each compression circuit 212. The compression buffer 211 temporarily holds the divided data. The plurality of compression results obtained from the compression circuit 212 are transferred to the transmission output buffer 213 and put together again. On the other hand, in the case of transfer without processing, the data is transferred to the transmission output buffer 213 without passing through the compression buffer 211 or the compression circuit 212.

When transferring the data from the reception input buffer 220 to the reception output buffer 223, the internode communication unit 104 can transfer the data without processing, or decompress and transfer the data according to whether the data is compressed by the internode communication unit 104 that is the transmission source. A plurality of decompression circuits 222 is provided for the decompression of the latter. In the case of the decompression and transfer, the plurality of decompression circuits 222 executes the decompression processing in parallel. The decompression buffer 221 is a buffer memory provided for each decompression circuit 222.

The transfer data is divided and distributed to each decompression circuit 222. The decompression buffer 221 temporarily holds the divided data. All of the plurality of decompression results obtained from the decompression circuit 222 have a predetermined size when being divided before the reversible compression, are transferred to the reception output buffer 223, and are put together again to return to the size before the reversible compression. On the other hand, in the case of transfer without processing, the data is transferred to the reception output buffer 223 without passing through the decompression buffer 221 or the decompression circuit 222.

For example, when the internode communication unit 104 is provided with 32 compression circuits 212, and when the 256 KB data is subjected to the reversible compression and transferred to another storage node, the data is divided into 8 KB, and one compression circuit 212 executes the 8 KB reversible compression. When the compression rate of the reversible compression by the compression circuit 212 is 50% on average, each compression result size is 4 KB on average. The compressed data size collected in the transmission output buffer 213 is 128 KB. The compressed data is sent to the internode communication unit 104 of another storage node.

The internode communication unit 104 on the reception side decompresses the received data in parallel by the plurality of decompression circuits 222 to restore the original data, and is transfers the original data to the CPU 103. At this time, each decompression result size by the decompression circuit 222 is 8 KB. Then, 32 decompression results are put together in the reception output buffer 223, and the original 256 KB data is obtained.

The internode communication unit 104 can reduce the size of the transfer data between the storage nodes using the compression circuit 212 and the decompression circuit 222 that are provided. When the compression rate of the reversible compression by the compression circuit 212 is 50%, this means that the transfer band between the storage nodes is apparently expanded 2 times. When the bottleneck of the performance of the storage system 100 is the transfer band between the storage nodes, the application of this compression is improvement of the bottleneck, and results in improvement of the system performance.

### (3) Read/Write Command

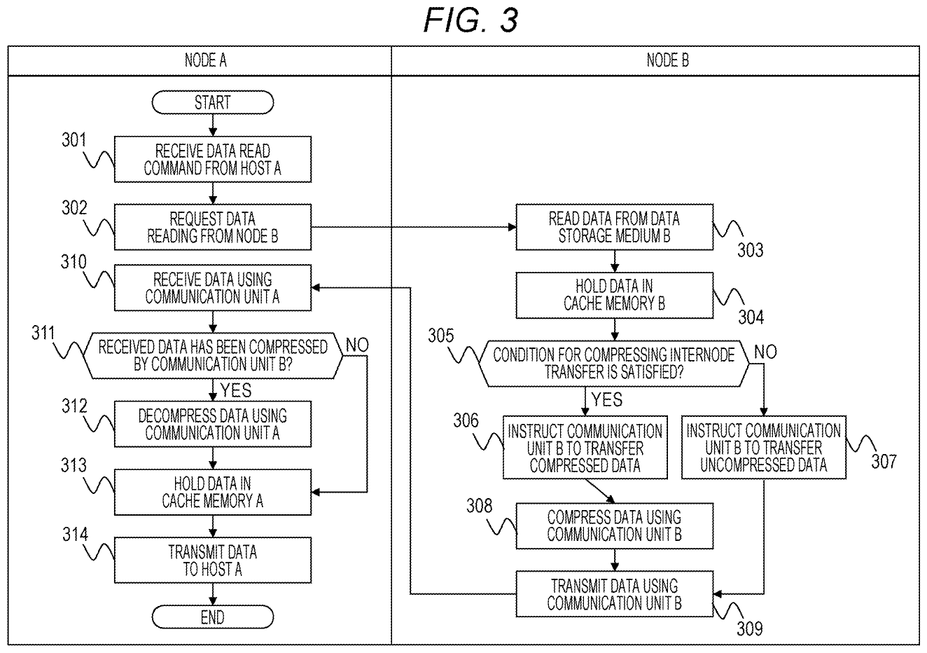

With reference to FIGS. 3, 4, and 5, the read/write command processing performed by the storage node 101 will be described.

FIG. 3 is a flowchart illustrating processing in which the storage node 101A reads data stored in the uncompressed state in the data storage medium 105B in the storage node 101B in response to the read command from the host 108A and returns the data to the host 108A.

First, the storage node 101A receives a data read command from the host 108A (301). Because the requested data is in the storage node 101B, the storage node 101B is requested to read data through the internode communication units 104A, 104B (302).

Subsequently, the storage node 101B reads data requested from the data storage medium 105B (303), and holds the data in the cache memory 106B (304). Then, the CPU 103B determines whether the condition for compressing the data during the internode communication is satisfied (305). Details of this condition will be described later. When the condition is not satisfied (NO), the CPU 103B instructs the internode communication unit 104B to transfer data to the storage node 101A in the uncompressed (unprocessed) state (307), and the internode communication unit 104B transmits the data to the storage node 101A as it is (309).

When the condition is satisfied in step 305 (YES), the CPU 103B instructs the internode communication unit 104B to transfer the data to the storage node 101A in the compression state (306), and the internode communication unit 104B compresses the data by the compression circuit 212 in FIG. 2 (308) and then transmits the data (309).

Subsequently, the internode communication unit 104A of the storage node 101A receives the data (310). The internode communication unit 104A determines whether the received data is compressed by the internode communication unit 104B (311). The transfer data includes data indicating the presence or absence of the compression. When the data is not compressed (unprocessed), the data is held in the cache memory 106A as it is (313). When the data is compressed, the data is decompressed by the decompression circuit 222 in FIG. 2 (312), and held in the cache memory 106A (313). The storage node 101A finally returns the data to the host 108A as a response to the read command (314).

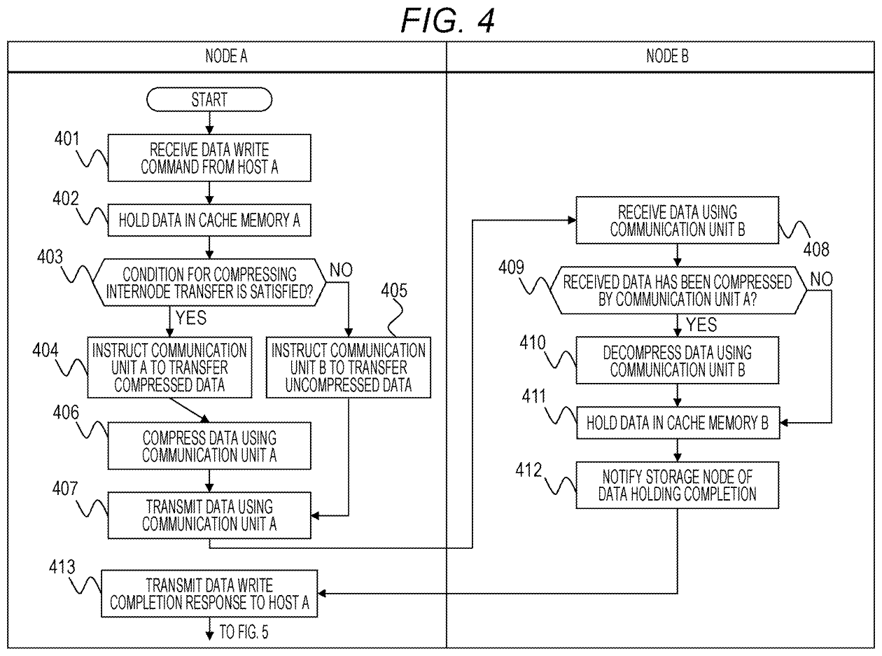

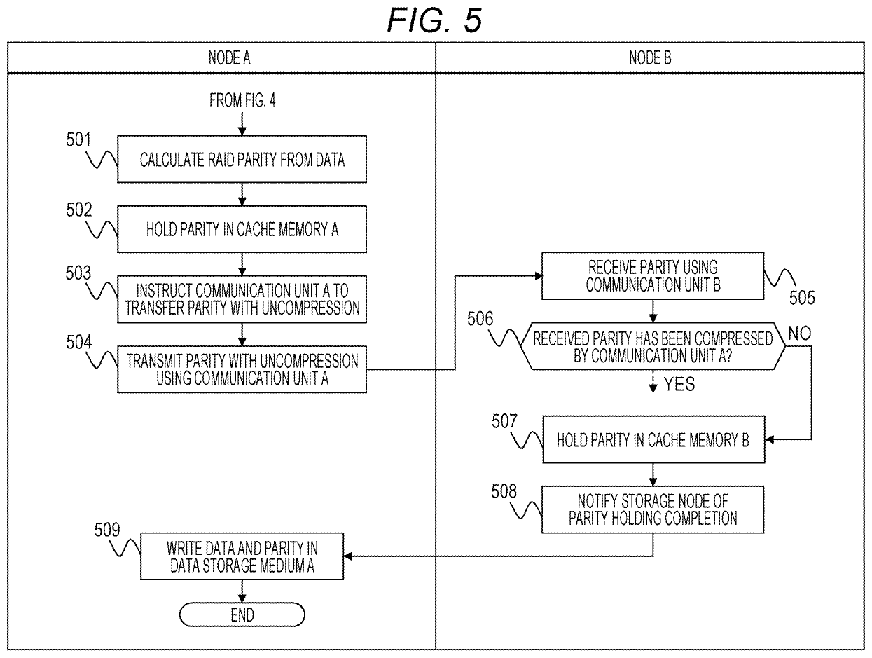

FIGS. 4 and 5 are a flowchart illustrating processing in which the storage node 101A writes the data to the data storage medium 105A in the storage node 101A in response to the write command from the host 108A.

First, in FIG. 4, the storage node 101A receives a data write command and the data to be written from the host 108A (401), and holds the data in the cache memory 106A (402). In order to prevent loss of the write data due to the failure of the storage node 101A (excluding the data storage medium 105A), this write data is also held as backup in the cache memory 106B in the storage node 101B. Step 403 to 412 below is a procedure for transferring the write data to the storage node 101B through the internode communication units 104A, 104B and holding the write data in the cache memory 106B.

The CPU 103A determines whether the condition for compressing the data during the internode communication is satisfied (403). Details of this condition will be described later. When the condition is not satisfied (NO), the CPU 103A instructs the internode communication unit 104A to transfer data to the storage node 101B in the uncompressed (unprocessed) state (405), and the internode communication unit 104A transmits data to the storage node 101B as it is (407).

When the condition is satisfied in step 403 (YES), the CPU 103A instructs the internode communication unit 104A to transfer data to the storage node 101B in the compression state (404), and the internode communication unit 104A compresses the data by the compression circuit 212 in FIG. 2 (406) and then transmits the data (407).

Subsequently, the internode communication unit 104B of the storage node 101B receives the data (408). The internode communication unit 104B determines whether the received data is compressed by the internode communication unit 104A (409). The transfer data includes the data indicating the presence or absence of the compression, and the data indicating the presence or absence of the compression is referred to. When the data is not compressed (unprocessed), the data is held in the cache memory 106B as it is (411). When the data is compressed, the data is decompressed by the decompression circuit 222 in FIG. 2 (410), and held in the cache memory 106B (411). The storage node 101B notifies the storage node 101A that the holding of the write data is completed through the internode communication units 104B, 104A (412).

Subsequently, the storage node 101A transmits a data write completion response to the host 108A (413). Although the data storage in the data storage medium 105A is not actually completed, the host 108A responds at this point such that the next command can be prepared at an early stage.

Subsequently, in FIG. 5, the CPU 103A of the storage node 101A calculates redundant arrays of independent disks (RAID) parity from the write data (501). The write data stored in the data storage medium 105A is recorded after redundancy based on a RAID technology is performed in order to prevent a data loss due to a medium failure.

Specifically, when the number of data storage media 105A is N, the CPU 103A evenly distributes and records the write data to (N−1) devices, and records the parity produced by calculating exclusive OR of the data in the remaining one device. Thus, even when one of the N devices fails, data recovery can be performed.

For example, when N=4, the CPU 103A records the data D1, D2, D3 of the same size in three devices, and records RAID parity P calculated by P=D1+D2+D3 (+indicates the exclusive OR) in the remaining one device. For example, when the recording destination medium of D2 fails, the CPU 103A recovers D2 using a property of P+D1+D3=D2. Because the parity P is produced by the exclusive OR of different data, its content is generally meaningless and random. In step 502, the CPU 103A stores the calculated parity in the cache memory 106A.

In order to prevent a loss of the parity due to the failure of the storage node 101A (excluding the data storage medium 105A), this parity is also held as the backup in the cache memory 106B in the storage node 101B. Step 503 to 508 below is the procedure for transferring the parity to the storage node 101B through the internode communication units 104A, 104B and holding the parity in the cache memory 106B.

The CPU 103A instructs the internode communication unit 104A to perform parity transfer to the storage node 101B with uncompression (without using the compression circuit 212 in FIG. 2) (503). The determination that the transfer is uncompression will be described later. The internode communication unit 104A directly transmits the parity to the storage node 101B (504).

Subsequently, the internode communication unit 104B of the storage node 101B receives the parity (505). The internode communication unit 104B determines whether the parity is compressed by the internode communication unit 104A (506). The transfer data includes the data indicating the presence or absence of the compression, and the data indicating the presence or absence of the compression is referred to. In this case, because the data is not compressed in the internode communication unit 104A, the data is held in the cache memory 106B as it is (507). The storage node 101B notifies the storage node 101A that the holding of the parity is completed through the internode communication units 104B, 104A (508).

Finally, the storage node 101A stores the write data and the parity held in the cache memory 106A in the data storage medium 105A (509). Thereafter, because there is no possibility that the write data is lost, the backup held in the cache memory 106B is invalidated.

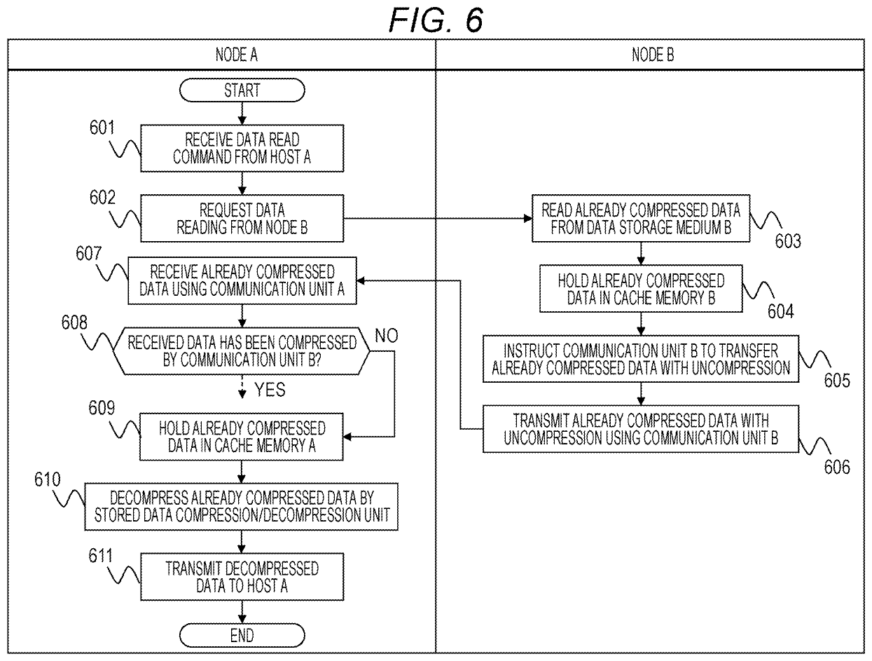

FIG. 6 is a flowchart illustrating processing in which the storage node 101A reads the data that is stored while compressed by the stored data compression/decompression unit 107B in the data storage medium 105B in the storage node 101B in response to the read command from the host 108A, decompresses the data, restores the data to a plaintext state, and returns the data to the host 108A.

First, the storage node 101A receives the data read command from the host 108A (601). Because the requested data is in the storage node 101B, the storage node 101B is requested to read data through the internode communication units 104A, 104B (602).

Subsequently, the storage node 101B reads the already compressed data requested from the data storage medium 105B (603), and holds the already compressed data in the cache memory 106B (604). Then, the CPU 103B instructs the internode communication unit 104B to transfer data to the storage node 101A with uncompression (without using the compression circuit 212 in FIG. 2) (605). The determination that the transfer is uncompression will be described later. The internode communication unit 104B directly transmits the already compressed data to the storage node 101A (606).

Subsequently, the internode communication unit 104A of the storage node 101A receives the already compressed data (607). The internode communication unit 104A determines whether the data is compressed by the internode communication unit 104B (608). The transfer data includes the data indicating the presence or absence of the compression, and the data indicating the presence or absence of the compression is referred to. In this case, because the data is not compressed in the internode communication unit 104B, the data is held in the cache memory 106A as it is (609). The storage node 101A decompresses the already compressed data using the stored data compression/decompression unit 107A, restores the decompressed data to the plaintext state, and holds the decompressed data in the cache memory 106A (610). Finally, the data is returned to the host 108A as the response to the read command (611).

### (4) Effect and Control of Compression by Internode Communication Unit

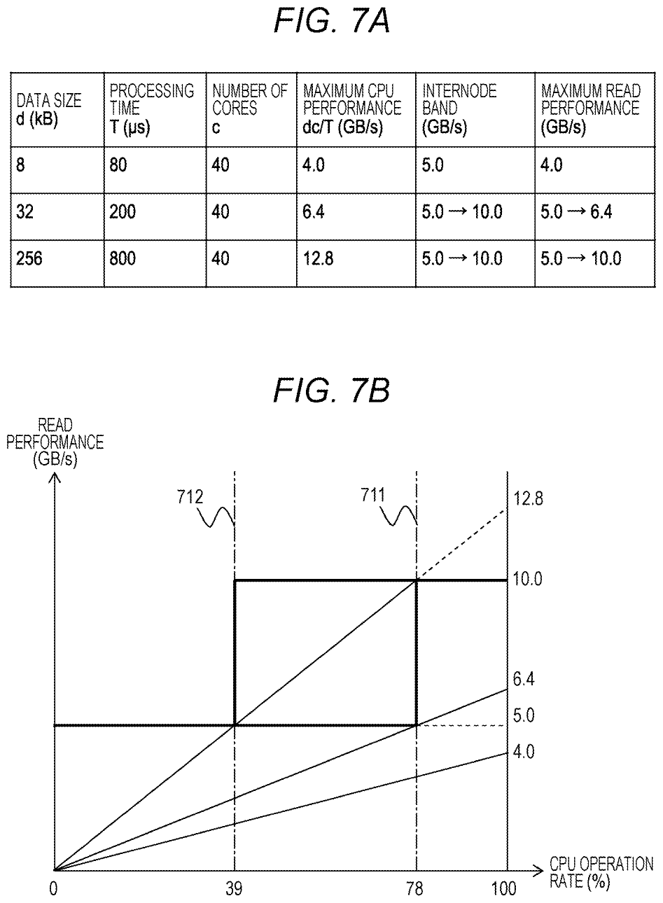

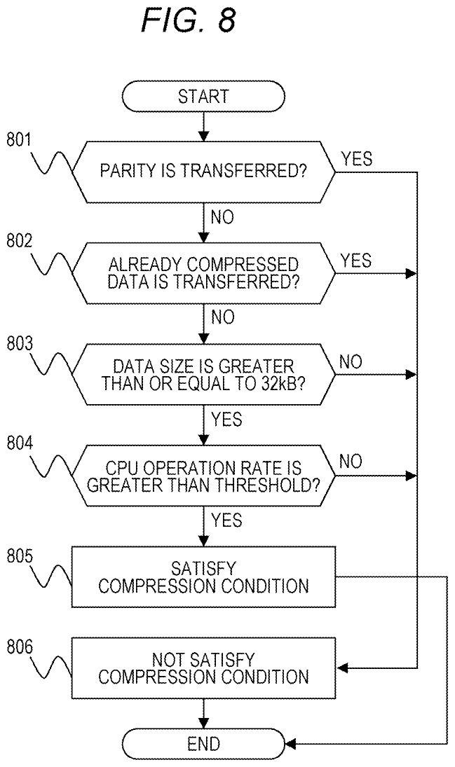

With reference to FIGS. 7A, 7B, and 8, effects of compressing communication between storage nodes and control of enabling and disabling of the compression will be described.

FIG. 7A is a table illustrating a method for calculating the maximum performance (maximum read performance, unit is GB/s) when the storage node 101 returns the data to the read command received from the host 108. The maximum read performance varies depending on a required data size d (KB) per read command. Time T(s) during which one microprocessor in the CPU 103 processes one read command is, for example, T=80 when d=8, T=200 when d=32, and T=800 when d=256.

Assuming that the number of cores c of the microprocessor included in the CPU 103 is 40, the read command processing performance of the CPU 103 is maximized when all the cores are operating, and the performance (maximum CPU performance, unit is GB/s) is obtained by dc/T. For example, the read command processing performance is 4.0 GB/s when d=8, 6.4 GB/s when d=32, and 12.8 GB/s when d=256. Even when the CPU 103 has such processing performance, when the transfer band of the path passing during sending of the read data to the host 108 does not satisfy the maximum CPU performance, the transfer band becomes the bottleneck and the maximum read performance becomes lower than the maximum CPU performance.

Now, when all the read commands from the host 108 request the data in the data storage medium 105 in another storage node 101 to which the host itself is not connected, all the data is transferred through the internode communication unit 104. It is assumed that this transfer band (internode band) is the lowest among paths through which the read data passes, and for example, is 5.0 GB/s. In this case, the maximum read performance is calculated. When d=8, because the maximum CPU performance is 4.0 GB/s, the internode band does not become the bottleneck and becomes 4.0 GB/s. When d=32 or 256, because the maximum CPU performance is 6.4 GB/s or 12.8 GB/s, the internode band becomes the bottleneck, and both are suppressed to 5.0 GB/s.

On the other hand, in the case of d=32 or 256, the internode communication unit 104 performs reversible compression on the transfer data and calculates the maximum read performance when the apparent band is expanded to 10.0 GB/s, which is twice. In the case of d=32, the internode band does not become the bottleneck, and the maximum read performance is improved to 6.4 GB/s. In the case of d=256, the internode band is still the bottleneck, but the maximum read performance is improved to 10.0 GB/s.

FIG. 7B illustrates a change in the read performance of the storage node 101 with respect to an operation rate (the number of operating cores/the total number of cores) of the CPU 103. With reference to FIG. 7B, a control method in which the CPU 103 enables and disables the compression by the internode communication unit 104 will be described. The CPU operation rate to be referred to is the operation rate of the CPU 103 of the storage node 101 that receives the read command or the write command from the host 108. The number of operating cores can be controlled in terms of power consumption and other factors. This point is a widely known technique, and details thereof are omitted.

First, in the case of d=8, because the internode band does not become the bottleneck of the read performance even when the CPU operation rate increases, the CPU 103 instructs the internode communication unit 104 to transfer the data in an uncompressed manner. The read performance can be improved up to 4.0 GB/s of the maximum CPU performance.

In the case of d=32, when the CPU operation rate is less than or equal to 78% (boundary line 711), because the internode band does not become the bottleneck of the read performance, the CPU 103 instructs the internode communication unit 104 to transfer the data in the uncompressed manner. However, when the CPU operation rate is more than 78% (boundary line 711), the CPU 103 instructs the internode communication unit 104 to transfer the data in a compressed manner in order to avoid the internode band from becoming the bottleneck of the read performance. The read performance can be improved up to 6.4 GB/s of the maximum CPU performance by the compression of the internode communication.

In the case of d=256, when the CPU operation rate is less than or equal to 39% (boundary line 712), because the internode band does not become the bottleneck of the read performance, the CPU 103 instructs the internode communication unit 104 to transfer the data in the uncompressed manner. However, when the CPU operation rate is more than 39% (boundary line 712), the CPU 103 instructs the internode communication unit 104 to transfer the data in the compressed manner in order to avoid the internode band from becoming the bottleneck of the read performance. The read performance can be improved up to 10.0 GB/s of the internode band (apparent band) by the compression of the internode communication.

As described above, more appropriate determination can be made by setting different thresholds of the CPU operation rate according to the requested data size d. The threshold of the common CPU operation rate may be set for different request data sizes d. According to the above control method, when the compression/decompression processing by the internode communication unit 104 is not effective in improving the read performance, the time required for the processing can be saved, and a wasted increase in the response time until the read data is returned to the host 108 can be prevented.

The description with reference to FIGS. 7A and 7B can be applied to the case where the storage node 101 returns the data write completion response to the write command received from the host 108. As described with reference to FIG. 4, the data received from the host 108 is transferred to another storage node 101 through the internode communication unit 104. The presence or absence of the compression in the internode communication unit 104 is determined such that the internode band does not become the bottleneck of the write performance. The CPU 103 of the storage node 101 that receives the write command from the host 108 determines the presence or absence of the compression in the internode communication unit 104 from the relationship between the operation rate of the CPU 103 and the prescribed threshold. As described above, one or the plurality of thresholds are set.

FIG. 8 is a flowchart illustrating steps (that is, 305, 403, 503, 605) in which the CPU 103 determines the condition (compression condition) for enabling the compression of the internode communication in the read/write command processing in FIGS. 3 to 6.

The CPU 103 checks whether the transfer target is the RAID parity (801), and in the case of true, the CPU 103 determines that the compression condition is not satisfied (806), and ends the determination. When step 801 is false, it is checked whether the transfer target is the already compressed data (802), and in the case of true, it is determined that the already compression condition is not satisfied (806), and the determination is terminated. When step 802 is false, it is checked whether the size of data requested to be read/written by the command is greater than or equal to the threshold (803). Here, the condition is greater than or equal to 32 kB as an example. When step 803 is false, it is determined that the compression condition is not satisfied (806), and the determination is terminated.

When step 803 is true, it is checked whether the CPU operation rate of the storage node 101 that receives the read/write command from the host 108 is larger than the predetermined threshold (804). When step 804 is false, it is determined that the compression condition is not satisfied (806), and the determination is terminated. When step 804 is true, it is determined that the compression condition is satisfied (805), and the determination is terminated.

The determination in step 801 or 802 is based on the fact that, because the RAID parity or the already compressed data is meaningless and a random content and have a small compression rate, even when the compression/decompression takes time, there is no effect on the expansion of the internode band, and the response time is only increased. The determination in step 803 is based on the fact that the internode band does not become the bottleneck of the read/write performance when the data size is small and the extension of the internode band is not required. The determination in step 804 is based on the fact that, when the CPU operation rate is less than or equal to the threshold (711 or 712 in FIG. 7B), the internode band does not become the bottleneck of the read/write performance and the internode band is not required to be extended. Only a part of the conditions in FIG. 8 may be determined, and all the conditions may not be determined.

### (5) Compression/Decompression Method by Internode Communication Unit

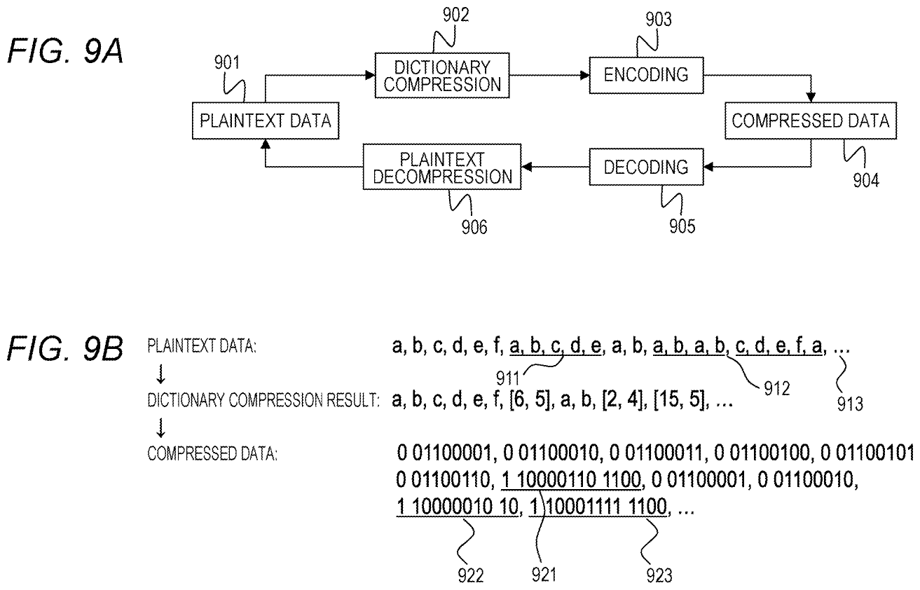

FIG. 9A illustrates an outline of a data compression/decompression method by the internode communication unit 104. In the compression processing performed by the internode communication unit 104 in the transfer source storage node 101, plaintext data 901 before the compression is first subjected to dictionary compression processing 902. Thereafter, the dictionary compression result is subjected to encoding processing 903 into a bit string. Thus, compressed data 904 output from the internode communication unit 104 to the transfer destination storage node 101 is generated.

On the other hand, in the decompression processing performed by the internode communication unit 104 in the transfer destination storage node 101, the compressed data 904 is first subjected to bit string decoding processing 905. Thereafter, the decoding result is subjected to plaintext decompression processing 906. Thus, the original plaintext data 901 is generated.

FIG. 9B illustrates a specific example of the dictionary compression processing 902. In the character string stream of the plaintext data 901, it is sequentially checked whether the same character string appears again. When a certain character string coincides with L consecutive characters from the front of J characters starting from the head character, the character string is converted into a copy symbol [J, L].

For example, 5-character character string 911 of “a, b, c, d, e” continuously coincides with 5 characters from the front of 6 characters starting from the first character “a”. In this case, a character string 911 is converted into a copy symbol [6, 5]. Similarly, a character string 912 of four characters of “a, b, a, b” is continuously matched with four characters from two characters before (including a portion overlapping each other) starting from the first character “a”. In this case, the character string 912 is converted into a copy symbol [2, 4]. Similarly, a character string 913 of 4 characters of “c, d, e, f” is continuously matched with 5 characters from the front of 15 characters starting from the first character “c”. In this case, the character string 913 is converted into a copy symbol [15, 5].

Because the data amount of these copy symbols is smaller than the data amount of the original character string, the data amount can be reduced by this conversion. A range of the character string stream (hereinafter, referred to as a dictionary) referred to in a matching search is a range from one character before to a predetermined number of characters before. Because the dictionary range slides backward every time the search is performed, this compression technique is also called slide dictionary type compression. When a plurality of matched character strings exist in the dictionary range, the longest consecutive matched character string is converted into the copy symbol. This has an effect of reducing the amount of data more.

In the encoding processing 903 in the subsequent stage, the character (hereinafter, referred to as a literal character) that is not converted into the copy symbol and copy symbol is encoded in a prescribed bit pattern, and the character and the copy symbol are concatenated to form a bit stream. The bit stream in FIG. 9B is the result of encoding according to specifications of an LZS (Lempel-Ziv-Stac) compression algorithm defined in RFC-2395. The copy symbol is encoded by concatenating the bit pattern representing a distance J to a copy source and a copy length L after a 1-bit “1”.

For example, a bit pattern 921 has a 13-bit length and represents the copy symbol [6, 5]. A bit pattern 922 has an 11-bit length and represents the copy symbol [2, 4]. A bit pattern 923 has a 13-bit length and represents the copy symbol [15, 5]. The bit length of the code corresponding to the copy symbol is not fixed. On the other hand, the literal character is represented by a 9-bit bit pattern in which one bit of “0” is added to the beginning of the 8-bit value of the character.

The decoding process 905 interprets such the bit stream and outputs the copy symbol or the literal character. Furthermore, in the plaintext decompression processing 906, the character string of the plaintext data 901 is sequentially restored from the beginning from the copy symbol and the literal character. When the copy symbol is decompressed into the character string, the restored character string is referred to as a dictionary. In the decompression of the copy symbol [J, L], the L character is extracted from a place where the J character returns from the end of the dictionary, and the L character is added to the end of the dictionary to be referred to next. In the decompression of the literal character, the dictionary in which one character is added to the end of the dictionary is referred to next.

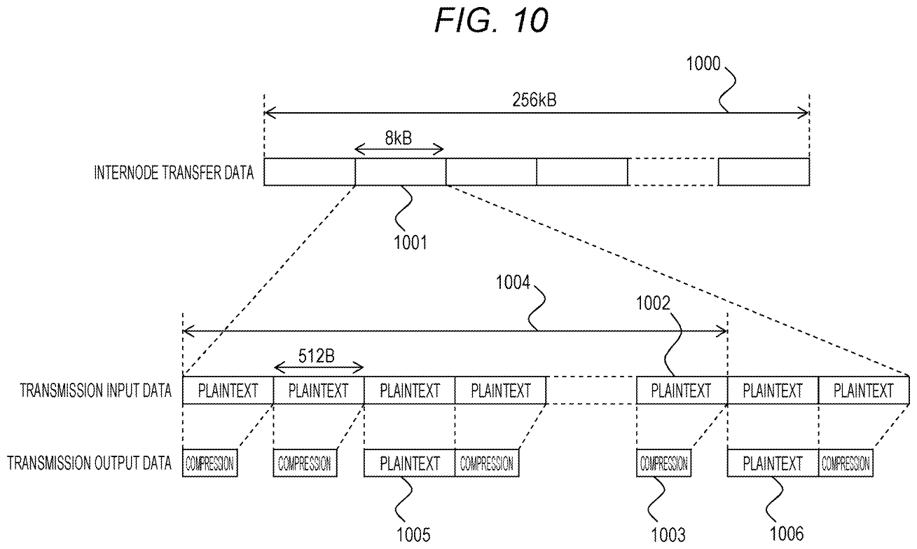

With reference to FIG. 10, a method for minimizing the processing time (hereinafter, referred to as a compression overhead time) increased by compressing and transferring the internode transfer data as compared with the time when the internode communication unit 104 transfers the internode transfer data without compressing the internode transfer data will be described.

As described with reference to FIG. 2, the internode communication unit 104 divides the internode transfer data into a predetermined size and compresses the data in parallel by the plurality of compression circuits 212. Assuming that the size of the internode transfer data 1000 is 256 kB and the predetermined size is 8 kB, the internode transfer data 1000 is divided into 32 8-kB portions 1001. One 8-kB portion 1001 is reversibly compressed by one compression circuit 212. When the 32 compression circuits 212 are mounted in the internode communication unit 104, because the compression processing can be performed in 32 parallel, the time required for compressing the 256-kB transfer data 1000 is only the time required for compressing one 8-kB portion 1001. That is, when the plurality of compression circuits 212 are provided and operated in parallel, the compression overhead time can be reduced.

In addition, the internode communication unit 104 divides the 8-kB portion 1001 into 16 512-B portions 1002, and individually performs the reversible compression on the 512-B portions 1002. For example, 1003 in FIG. 10 illustrates this. As soon as the compression of each 512-B portion 1002 is completed, the PCIexpress packet having the compression result as the payload is formed and transmitted to the internode communication unit 104 as the transmission destination. Thus, the waiting time until the data obtained by compressing the 8-kB portion 1001 is sent is a time required for compressing one 512-B portion 1002. That is, when partial results in the middle of the compression processing is sequentially sent, the compression overhead time can be reduced.

The dictionary range referred to when the 512-B portion 1002 is subjected to the reversible compression by the method in FIG. 9B is the range from the head of the 8-kB portion 1001 including the dictionary range to the dictionary range (range indicated by 1004 in FIG. 10). Because the number of character string candidates that can be used as the dictionary is greater than the number of character string candidates when only the 512-B portion 1002 is set to the dictionary range, there is an effect that the compression rate is improved to compress the data amount smaller (the apparent transfer band is further expanded).

In addition, when the result of individually performing the reversible compression on the 512-B portion 1002 is greater than 512 B, the packet having the 512-B portion before compression as the payload is transmitted instead of transmitting the packet having the compression result as the payload. This has the effect of preventing a problem that the amount of transfer data is increased by the compression to reduce the apparent transfer band. For example, reference numerals 1005 or 1006 in FIG. 10 indicate this. As illustrated in FIG. 9B, because the data amount of the literal character increases 9/8 times by being encoded into a 9-bit pattern, there is a high possibility that the 512-B portion 1002 having a very low frequency of the copy symbol exceeds 512 B by the compression.

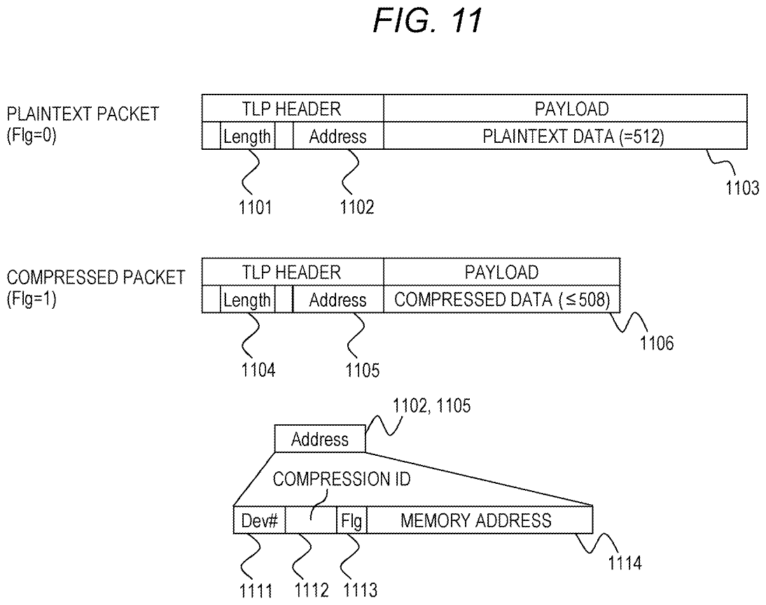

FIG. 11 is a view illustrating a configuration of the PCIexpress packet transmitted and received by the internode communication unit 104 under the condition for compressing and transferring the internode transfer data.

The PCIexpress packet generally includes a TLP header and a payload. The TLP header includes a length field indicating a byte length of the payload and an address field including a transmission destination address and the like. The payload is a data body to be transmitted. As described with reference to FIG. 10, the data is transferred in the compressed state when the 512-B portion is reduced by the reversible compression, and transferred in the plaintext state when the 512-B portion is not reduced.

The packet transmitting the data of 512 B in the plaintext state is referred to as a plaintext packet, and the packet transmitting the data less than 512 B in the compressed state is referred to as a compressed packet. 512-B plaintext data 1103 (corresponding to 1005 or 1006 in FIG. 10) is set in the payload of the plaintext packet, and “512” is set in a length field 1101 of the TLP header. Compressed data 1106 (corresponding to 1003 in FIG. 10) less than or equal to 508 B is set in the payload of the compressed packet, and the byte length of 1106 is set in a length field 1104 of the TLP header. The reason why the size of the compressed data 1106 is less than or equal to 508 byte is that the payload size of the PCIexpress packet is defined as a multiple of 4 in principle. Accordingly, when the compression result is 509 to 511 bytes, the data is transferred as the plaintext packet.

In the plaintext packet and the compressed packet, an address field 1102 or 1105 of the TLP header includes the following items. That is, the address field 1102 or 1105 includes a transmission destination memory address 1114, a device number 1111, a compression circuit ID 1112, and a compression state determination flag 1113.

The transmission destination memory address 1114 is a destination address when the data of the payload is stored in the cache memory 106 in the storage node 101 of the transmission destination. In the case of the compressed packet, the address is an address storing the decompressed 512-B data. That is, when the 8-kB portion is transmitted in 16 packets, the 16 transmission destination memory addresses 1114 included in the 8-kB portion are allocated with the value of a 512-B interval.

The device number 1111 is a unique number identifying the internode communication unit 104 mounted on the storage node 101 to which the plaintext and compressed packet is transferred. The hub device 110 in FIG. 1 detects the device number 1111 included in the address of the TLP header of the received packet and switches the transfer destination of the packet. The compression circuit ID 1112 is an identifier of the compression circuit. The compression circuit ID 1112 is a unique number identifying which compression circuit in the plurality of compression circuits 212 in the internode communication unit 104 that transmits the packet performs the compression processing on the payload of the packet.

The internode communication unit 104 that receives the packet performs the payload decompression processing on the packet including the same compression circuit ID 1112 in the address of the TLP header using the common decompression circuit 222. This is because, as indicated by reference numeral 1004 in FIG. 10, the dictionary range referred to in the compression processing of the 8-kB portion 1001 is shared by the plurality of 512-B portions 1002, and thus, it is necessary to use the same decompression circuit 222 is required for the use in order to correctly decompress the data obtained by compressing the 512-B portions.

The compression state determination flag 1113 is information for the decompression circuit 222 to identify whether the packet is the plaintext packet or the compressed packet. When the compression state determination flag 1113 is “1”, the payload decompression processing is executed as the compressed packet, but when the compression state determination flag 1113 is “0”, the payload decompression processing is bypassed as the plaintext packet.

In the embodiment, the 512-B data is obtained from the payload of the plaintext packet, and the 512-B data is obtained by decompressing the payload of the compressed packet by the decompression circuit 222. That is, the data is always transferred to the reception output buffer 223 in FIG. 2 in 512-B units. As described in the description of FIG. 1, in the PCIexpress connection in which the CPU 103 is RootComplex and the internode communication unit 104 is EndPoint, the maximum payload size of the write transfer packet to the cache memory 106 is 512 B.

By simply attaching the TLP header (one in which the address of the cache memory 106 is set in the address field) to each piece of the data held in the reception output buffer 223 in 512-B units, the packet that can be written and transferred to the cache memory 106 can be formed as it is, so that the transmission processing of PCIexpress is made efficient. When the data is held in units other than 512 B, a data size counter or a data division and concatenation circuit is required, but this can be omitted in the embodiment.

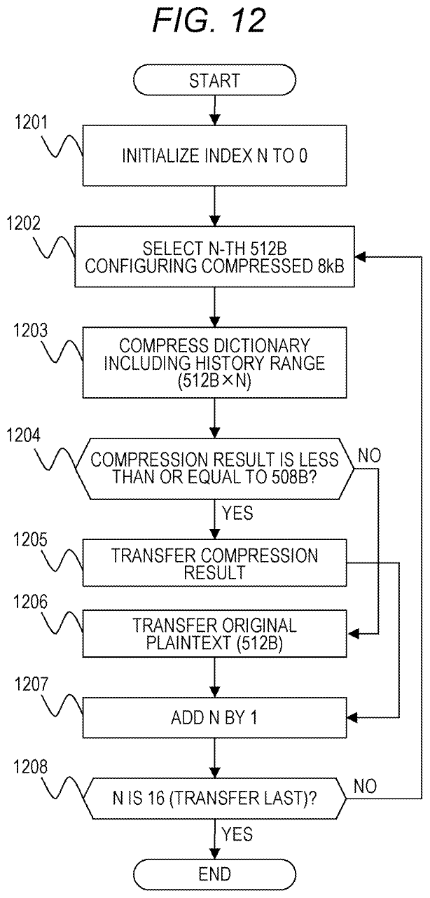

FIG. 12 is a flowchart when the compression circuit 212 of the internode communication unit 104 executes the compression processing of the 8-kB portion under the condition for compressing and transferring the internode transfer data. First, the index N is initialized to 0 (1201), and the processing proceeds to step 1202.

In step 1202, Nth (starting is set to 0) 512 B is selected from 16 of 512 B constituting the 8-kB portion to be compressed. Then, for the selected 512 B, the history range (512 B×N) is included in the dictionary, and the dictionary compression is performed (1203). It is checked whether the size of the compression result is less than or equal to 508 B (1204). When this is true, the compression result is transferred to the transmission output buffer 213 in order to use the compression result as the payload (1205). When step 1204 is false, the compression result is transferred to the transmit output buffer 213 in order to use the original plaintext (512 B) as the payload (1206).

After step 1205 or 1206, N is added by 1 (1207). It is checked whether N is 16 (1208). When N is 16, the compression processing is completed. When N is not 16, the processing returns to step 1202, and the compression processing is continued for the next 512 B. At that time, the dictionary range used in the dictionary compression in step 1203 includes (N−1) pieces of 512 B processed so far.

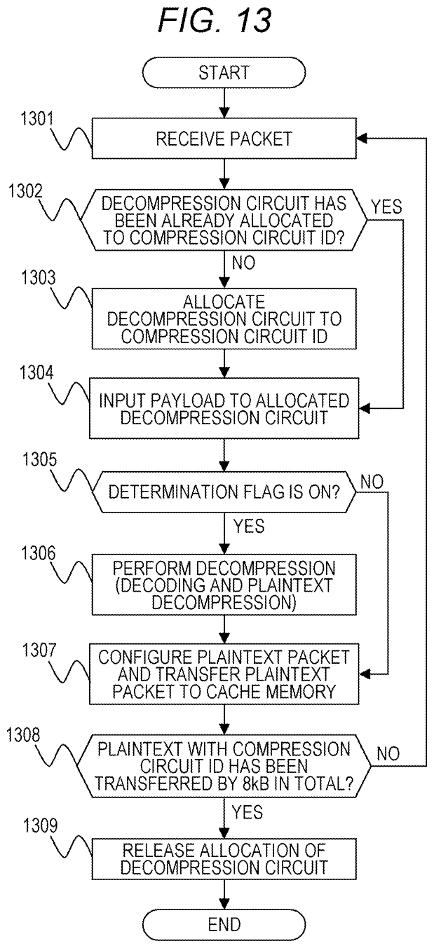

FIG. 13 is a flowchart when the internode communication unit 104 decompresses the 8-kB portion compressed using the compression circuit 212 by the decompression circuit 222 and transfers the decompressed the 8-kB portion to the cache memory 106.

First, the internode communication unit 104 receives the packet (1301), and checks whether one of the decompression circuits 222 is already allocated to the compression circuit ID in the TLP header of the received packet (1302). When the allocation is already completed, the processing proceeds to step 1304. When the allocation is not completed, one of the decompression circuits 222 is allocated (1303), and the processing proceeds to step 1304.

In step 1304, the payload of the received packet is input to the allocated decompression circuit 222. Then, it is checked whether the compression state determination flag in the TLP header of the received packet is ON (compression state) (1305). When the compression state determination flag is OFF (plaintext state), the processing proceeds to step 1307. When the compression state determination flag is ON, the decompression circuit 222 decompresses the payload (decrypts and decompresses the plaintext by dictionary reference) to restore the 512-B plaintext (1306), and the processing proceeds to step 1307.

In step 1307, the packet for the memory write is configured with 512-B plaintext (the restoration result or the payload itself), and transferred to the cache memory 106. Then, it is checked whether the plaintext obtained from the received packet to which the compression circuit ID is attached is already transferred by 8 kB in total (1308). When 8 KB is already transferred, the allocation of the decompression circuit 222 is released and the processing is completed. When 8 KB is not transferred yet, the processing returns to the reception of the subsequent packet (1301) and continues. At this time, the dictionary range referred to in the plaintext decompression in step 1306 includes all the plaintexts decompressed after the allocation of the decompression circuit.

As described above, according to the embodiment, the compression/decompression of the communication data is executed only when the communication band between the storage nodes becomes the bottleneck of the performance of the data reading or the data writing in the storage system, so that a waste of the processing time of the compression/decompression can be avoided. In addition, the waste of the processing time of the compression/decompression can be avoided by performing the compression/decompression only on compressible communication data (data other than RAID parity or already compressed data).

According to the embodiment, the data is divided and compressed with the maximum payload size of the write packet from the communication unit to the cache memory, so that the write packet can be easily configured and the data transfer can be made efficient. In addition, the dictionary range is shared in the dictionary compression of the plurality of divided data, so that the compression rate can be improved (the data amount can be further reduced) to further expand the apparent communication band between the storage nodes and the data reading/writing performance can be improved.

### (6) Other Embodiments

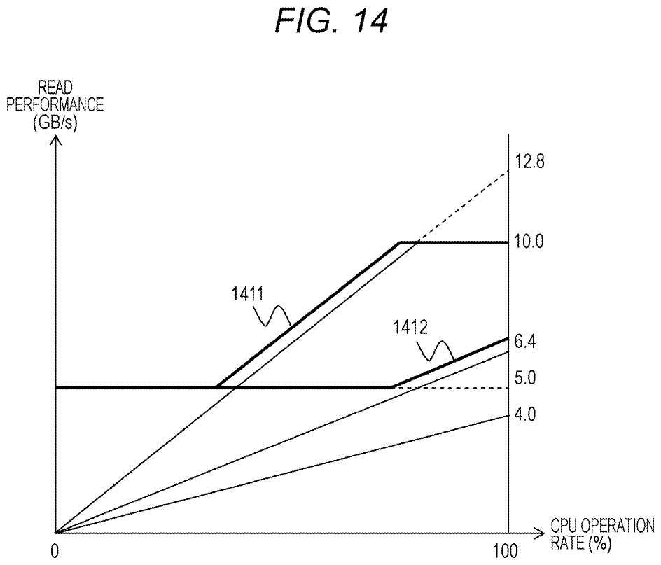

With reference to FIG. 14, another example of the control method in which the CPU 103 enables and disables the compression by the internode communication unit 104 will be described. This example is implemented by changing step 804 in the flowchart of FIG. 8 to a conditional expression “transmission output speed by internode communication unit−CPU performance <threshold?”. At this point, the transmission output source is an internode communication unit of the storage node storing the read data, and the transmission output destination is an internode communication unit of the storage node receiving the read command. This condition may be further added without changing step 804 described above. FIG. 14 illustrates changes in the transmission output speed by the internode communication unit 104 and the read performance of the storage node 101 in this example. The CPU performance can be calculated from the CPU operation rate according to a prescribed mathematical formula.

When an issuing frequency of the read command from the host 108 increases, the CPU performance increases as the CPU operation rate increases. However, when the compression of the transfer data by the internode communication unit 104 is disabled, because an upper limit of the transmission output speed is 5.0 GB/s, the difference from the CPU performance decreases. When it falls below the threshold, the process proceeds to step 805, and the transmission output speed increases as the ratio of the transfer data for enabling the compression increases. As a result, when the difference from the CPU performance increases, it becomes greater than or equal to the threshold and the processing proceeds to step 806, and the ratio of the transfer data enabling the compression decreases. That is, by changing to this conditional expression, the transmission output speed by the internode communication unit 104 is maintained at a speed higher than the CPU performance by the threshold.

A bold line 1411 and a bold line 1412 in FIG. 14 are changes in the transmission output speed according to the example. Until the transmission output speed reaches 10 GB/s that is the transmission output speed when the transfer data compression is always effective, the bottleneck of the read performance becomes the CPU performance. In this control method, because the internode communication unit 104 does not enable the compression of the transfer data more than necessary, the generation of the compression overhead time can be reduced as compared with the previous control method, and a wasted increase of the response time until the read data is returned to the host 108 can be further prevented.

The above description can also be applied to the processing for the write command. In step 804, the conditional expression “transmission output speed by internode communication unit−CPU performance <threshold?” is also set for the processing of the write command. At this point, the transmission output source is an internode communication unit of the storage node that receives the write command, and the transmission output destination is an internode communication unit of another storage node. When the ratio of the transfer data enabling the compression is increased by the control method of this example, the following priority command control may be performed. For example, a parameter indicating whether to permit the increase in the response time is added to the read/write command from the host 108, and the internode communication data generated by the processing of the command in which the parameter is set to “no” is not selected as much as possible as the compression validation target. Thus, degradation of the response time can be minimized for a command that the host 108 does not want to degrade the response time.

The present invention is not limited to the above embodiment, and various modifications may be provided. For example, the above embodiment is described in detail for the purpose of easy understanding of the present invention, and do not necessarily include all the described configurations. A part of the configuration of an embodiment can be replaced with the configuration of another embodiment, and the configuration of another embodiment can be added to the configuration of an embodiment. Furthermore, another configuration can be added to, deleted from, and replaced with other configurations for a part of the configuration of each embodiment.

Some or all of the configurations, functions, processing units, and the like may be designed with, for example, an integrated circuit, and implemented by hardware. Furthermore, the above-described respective components, functions, and the like may be implemented by software by the processor interpreting and executing a program implementing the respective functions. Information such as a program, a table, and a file, that implements each function can be stored in a memory, a recording device such as a hard disk and a solid state drive (SSD), or a recording medium such as an IC card, and an SD card.

The control line and the information line indicate those which are considered required for the description, but do not necessarily indicate all the control lines and information lines that are required for the product. Actually, it can be considered that almost all the components are connected to each other.

What is claimed is:

1. A storage system comprising a plurality of storage nodes, wherein
each storage node of the plurality of storage nodes includes:
a processor that processes an instruction from an outside;
a drive that stores data; and
a communication unit that transmits data to another storage node or receives data from the another storage node,
the communication unit includes a compression circuit that performs reversible compression before data is transmitted and a decompression circuit that decompresses compressed data after the compressed data is received,
when a predetermined condition is satisfied, the communication unit of a first storage node compresses the data stored in the drive of the first storage node by the compression circuit and transmits the compressed data to the communication unit of a second storage node in response to a reading command for reading data of a designated size to the outside,
the communication unit of the second storage node decompresses the received data using the decompression circuit, and
the second storage node outputs the decompressed data to the outside.

2. The storage system according to claim 1, wherein
the condition includes a condition in which the size designated by the reading command is greater than or equal to a threshold.

3. The storage system according to claim 1, wherein
the condition includes a condition in which the data instructed by the reading command is stored in the drive in an uncompressed state.

4. The storage system according to claim 1, wherein
the condition includes a condition in which an operation rate of the processor of the second storage node exceeds a threshold.

5. The storage system according to claim 1, wherein
the condition includes a condition in which a difference obtained by subtracting processing performance of the reading command by the processor of the second storage node from a transmission output speed of data from the communication unit of the first storage node to the communication unit of the second storage node is less than a threshold.

6. A storage system comprising a plurality of storage nodes, wherein
each storage node of the plurality of storage nodes includes:
a processor that processes an instruction from an outside;
a drive that stores data;
a cache memory; and
a communication unit that transmits data to another storage node or receives data from the another storage node,
the communication unit includes a compression circuit that performs reversible compression before data is transmitted and a decompression circuit that decompresses compressed data after the compressed data is received,
when a predetermined condition is satisfied, the communication unit of the first storage node compresses the data of the cache memory of the first storage node by the compression circuit and transmits the compressed data to the communication unit of the second storage node in response to a writing command for writing received data of a designated size from the outside,
the communication unit of the second storage node decompresses the received data using the decompression circuit, and
the second storage node stores the decompressed data to the cache memory.

7. The storage system according to claim 6, wherein
the condition includes a condition in which the size designated by the writing command is greater than or equal to a threshold.

8. The storage system according to claim 6, wherein
the condition includes a condition in which the data of the cache memory is not RAID parity calculated from the received data.

9. The storage system according to claim 6, wherein
the condition includes a condition in which an operation rate of the processor of the first storage node exceeds a threshold.

10. The storage system according to claim 6, wherein
the condition includes a condition in which a difference obtained by subtracting processing performance of the writing command by the processor of the second storage node from a transmission output speed of data from the communication unit of the first storage node to the second storage node is less than a threshold.

11. A storage system comprising a plurality of storage nodes, wherein
each storage node of the plurality of storage nodes includes:
a cache memory; and
a communication unit that transmits data to another storage node or receives data from the another storage node,
the communication unit includes a compression circuit that performs reversible compression before data is transmitted and a decompression circuit that decompresses compressed data after the compressed data is received,
the communication unit of a first storage node divides data into a plurality of pieces of partial data with a maximum payload size of write packet from the communication unit to the cache memory as a division unit, and transmits packet having a payload obtained by compressing the partial data using the compression circuit to the communication unit of the second storage node, and
the communication unit of the second storage node that receives the packet decompresses the payload of the received packet by the decompression circuit, configures write packet including the decompressed payload, and transfers the write packet to the cache memory of the second storage node.

12. The storage system according to claim 11, wherein
a compression algorithm by the compression circuit is dictionary compression, and a range of a dictionary referred to in the dictionary compression includes a plurality of pieces of the partial data compressed by the compression circuit.

13. The storage system according to claim 11, wherein
the communication unit includes a plurality of compression circuits and a plurality of decompression circuits,
the communication unit of the first storage node adds an identifier of the used compression circuit to the packet to be transmitted to the communication unit of the second storage node, and
the communication unit of the second storage node selects one common decompression circuit in the plurality of decompression circuits for a plurality of packets including the identifier.

14. The storage system according to claim 11, wherein
the communication unit of the first storage node adds a flag indicating that the payload is in a compressed state to the packet to be transmitted to the communication unit of the second storage node, and
the communication unit of the second storage node determines whether the payload is decompressed by the decompression circuit according to the flag.
